(19) United States
(12) Patent Application Publication
(10) Pub. No.: US 2007/0234854 A1
(43) Pub. Date: Oct. 11, 2007

(54) Bendable-head power ratchet tool

(76) Inventor: Ronny Collins, Gig Harbor, WA (US)

Correspondence Address: LAMBERT & ASSOCIATES, PO BOX 4063, RESTON, WA, 98057, US

(21) Appl. No.: 11/807,430

(22) Filed: May 29, 2007

Related U.S. Application Data
(63) Continuation-in-part of application No. 11/272,839, filed on Nov. 13, 2005, now abandoned.
(63) Continuation-in-part of application No. 11/712,820, filed on Mar. 1, 2007, now abandoned.

(51) Int. Cl. B25B 21/00

(52) U.S. Cl. 81/58.1

(57) ABSTRACT

A bendable-head power ratchet tool is described in which a conventional motor body is connected to a conventional socket head ratchet mechanism by a unique two-piece split-shaft the pieces of which articulate in the Z-axis while delivering torque. The driveshaft and foreshaft are coupled by a pivotable shaft coupling made from a simple and rugged slotted ball with wristpin in mating socket. Surprisingly simple, the pivotable shaft coupling may be assembled by merely dropping the foreshaft onto the driveshaft in place in the housing. Such ratchet tools may be pneumatic or electric. A preferred embodiment is an air-powered bendable head ratchet wrench.

### CROSS-REFERENCE TO RELATED APPLICATIONS

This application claims priority to and is a continuation-in-part of U.S. patent application Ser. No. 11/712,820, filed 1 Mar. 2007, which claims the benefit under 35 U.S.C. 35 U.S.C. §120 of U.S. patent application Ser. No. 11/272,839, filed 13 Nov. 2005. The full disclosures of said priority documents hereby are incorporated by reference for use herein in their entireties.

### BACKGROUND TO THE PROBLEM

Ratchet-action wrenches, also termed “nutdrivers” or “socket wrenches”, have many uses for skilled mechanics, who maintain a collection of these tools for their work. These hand-held tools typically are used with interchangeable “socket bits” available in various sizes and shapes. The conventional tool is well known in the mechanic's arts and consists of a source of rotary force, a prior art means to convert that force into ratcheted, pawl-, pinion gear- or cogwheel-driven rotation of the socket bit, a shaft joining the ratchet means and the motor means, and a handle to control the position of the tool. An on/off switch, control lever, or variable power switch is typically mounted on the handle. A means to reverse the direction of rotation of the socket bit is typically provided on the ratchet head, as may be a variable clutch. The most common such tools are driven by an air motor and typically contain planetary reduction gears for delivery of higher torque. The torque achieved is dependent on the air or power consumption, the reduction ratio of the gearing, and the efficiency of the head mechanism. Electrically powered ratchet tools are also commonly available.

Ratchet-action power tools are provided with a wide variety of english and metric socket bits for various members or fasteners, including pipe wrenches, ring clamp wrenches, and fittings to remove oil filters, as well as the more commonly recognized socket bits for removing and assembling nuts, bolts, splines and screws. Ratchet screwdrivers are also commonly available.

Among the challenges faced by mechanics are access to such nuts, bolts and screws, collectively termed members or fasteners, as are in tight or awkward spaces and at angles where a socket wrench won't line up on the head of the fastener, such as on the bell housing of a transmission on a vehicle undercarriage. At times it is necessary that the tool wrap around a difficult angle in order for the socket bit to be mounted squarely on the head of the fastener so as to safely apply torque without damage to the head of the nut, bolt, fastener, or other fitting, and without slipping.

Headspace clearance for the socket tool head is also a problem. Although a “wobbly” socket bit adaptor or a “universal joint” socket bit adaptor, can be useful in accessing hard to reach bolts or nuts, these compound bits require about two to three times more head clearance than a standard socket bit, limiting their use to special situations. Furthermore, they cannot be reliably used to manually torque a fitting.

A power ratchet wrench is sometimes used manually. After tightening a bolt or nut to the limit of torque that the power motor can apply, the power is turned off and arm muscle is used to further torque the fastener. Similarly, it is sometimes necessary to loosen a bolt or nut manually before using a power tool to complete the job. Not all wrench designs are sturdy enough for this application. These tools must be rugged.

Power ratchet wrenches first appear in the US Patent Office database in about 1955. See U.S. Pat. No. 2,711,111 to Brame (open box wrench) and U.S. Pat. No. 2,725,771 to Arnold (closed box wrench). Present day features, such as interchangeable socket bits, are clearly apparent in designs by Northcutt (U.S. Pat. No. 3,529,498) and Hanson (U.S. Pat. No. 4,346,630) dating from the 1970's.

Since then, incremental improvements include torque limiting clutches and transmissions to reduce kickback (see U.S. Pat. Nos. 6,093,128, 6,076,438, 5,558,168, 5,167,309, and 3,298,481), air exhaust deflectors and mufflers for safety and noise reduction (see US Patent Applications 20050039934, 20050103566, and 20040177980), work lighting accessories (see US 20050062428 and U.S. Pat. No. 5,267,129), quick release and rotational reversing mechanisms (as exemplified in US 20070028724, 20050087041 and U.S. Pat. No. 4,211,127), torque multipliers (US 20060090606), US 20060053979, US 20060053980, and US 20050211026 (with increased mechanical strength), among others. Very recently, cordless electrical designs have appeared, some with digital interfaces. We see the beginning of integration of digital circuits for example in US 20060283265.

Ratchet-action head mechanisms and motors of the prior art are exemplified in the US Patent Office database by U.S. Reissue 33711, U.S. Pat. No. 5,896,789, 5,535,646, 5,017,109, 4,821,611, and 4,791,836, and by US Patent Applications 20030024715 and 20020148331, for example.

A number of patent documents relate to ratchet head modifications for access to fasteners at variable angles. Generally, these can be divided into ratchet heads that rotate or pivot on the X-axis, where X is defined as the rotational, or “long”, axis of the motor driveshaft, on a Y-axis, where a Y-axis defines a pivot axis of the head at the neck that is parallel to the spin of the socket bit stub (ie. side to side), or on a Z-pivot axis, where any Z-pivot axis defines an axis similar to that of the bending of the hand relative to the plane occupied by the radius and ulna (ie. up and down on the wrist). As termed here, the long axis of the motor driveshaft by definition shall have its “proximal” end abutting the motor and its “distal” end facing the head.

To be clear, a Z-pivot axis flexing ratchet wrench has a head motion analogous to the flexion of the fingers on the palm, or the hand at the human wrist (up and down with palm up), or the flexion at the elbow, where the X-axis is taken to follow the length of the arm, and the Y-axis of the wrist is taken to represent the motion of the hand from side to side with palm up. The anatomical analogy can be extended further, and a wrench that bends at the fingers may not be as strong as a wrench that bends at the elbow. An elbow has a long lever arm and little or no Y-axis rotation because rigidity is important in applying force while turning the arm at the shoulder. So too it is with certain tools.

Examples of variable angle head ratchet tools include U.S. Pat. No. 5,577,425 to Holmin and Wallerius, which rotates on a lip-joint on the X-axis, and U.S. Pat. No. 5,784,934 to Izumisawa, which rotates on a Y-axis while driven by beveled gears. U.S. Design Pat. 372850 is provided as an example of an electric nutrunner having rotating head motion on the X-axis. An interesting flex cable wrench is illustrated in U.S. Pat. No. 6,813,975 to Kozak.

U.S. Pat. No. 4,993,288 to Anderson describes a single-shaft box wrench tool head that flexes on a Z-pivot axis drawn through ratchet head ears (U.S. Pat. No. 4,993,288 FIG. 2, element 20), the “yoke”, or “tang” of the rocker member (See U.S. Pat. No. 4,993,288 FIG. 2, element 40), and through the excentric cam or “ball crank member” (U.S. Pat. No. 4,993,288 FIG. 4—element 16, herein termed an “excentric crankpin”). By positioning the Z-axis of flexion on the rocker yoke mechanism, the wrench is necessarily broader at the head than a conventional ratchet wrench. Also, placement of the Z-axis of the flex ratchet head on this pivot line requires tenting of the “pocket” formed by the rocker lug ears and the inside top and bottom faces of the ratchet head so as to accommodate the out of plane, excentric displacement of the crankpin bushing when the head bends. This again increases the dimensions of the head (FIG. 1 element 21, making access to tight places more difficult. In the drawings, the radial offset of the crankpin on the driveshaft can be seen (see FIG. 7 of U.S. Pat. No. 4,993,288) to be noticeably less than that of a conventional ratchet head because, in the '288 design, a fully excentric crankpin and bushing would exit the rocker yoke at the most out-of-plane orbital rotation of each cycle, and even impinge on the ratchet head body if the body cavity were not tented, resulting in vibration and excessive wear. The shorter power stroke also reduces the ratchet drive efficiency and the torque that may be applied by ratchet heads of this design (which, parenthetically, cannot be used with conventional interchangeable socket bits intended for attachment to the tool by a stud).

U.S. Pat. No. 6,435,060 to Izumisawa also describes a ratchet wrench bending at the Z-axis on a slider bar that extends through the mechanism from right to left. In this wrench design, the pivot axis is a solid fixed cross-bar (U.S. Pat. No. 6,435,060 FIG. 1, element P). A cam pin and bushing (U.S. Pat. No. 6,435,060 FIG. 1, elements 18 and 30) mounted to the driveshaft are used to drive slave carriage element 31 with yoke and coupling element 32 with pin 32a and bushing 33 (U.S. Pat. No. 6,435,060 FIG. 1, elements 31-33), that ride, slidingly back and forth, on the fixed position pivot bar P. Ingeniously, this converts axial rotation of the driveshaft and cam pin into transverse reciprocal motion of the carriage and coupling adaptor, which in turn actuates the ratchet rocker dog and pawls. The neck of the device is, however, necessarily broad to accommodate the carriage and required pivot ears. A wrench of this type was manufactured and sold briefly as the “AT714—“Cobra Head” ⅜” Flexible Air Ratchet Wrench” but has since been withdrawn from market. To verify this, examine the manufacturer's exploded view (used to order replacement parts, last accessed 4 Jan. 2007, at http://buy1.snapon.com/catalog/parts/pro_det.asp?Item_id=68240&group_id=17685), and then compare it with FIG. 1 of U.S. Pat. No. 6,435,060. In both drawings we see a slender cylindrical bushing inserted between pivot post P and the carriage and coupling elements 31 and 32. While not numbered in the patent drawings, the bushing as drawn is delicate and tripartite. This reciprocally sliding bushing would not perform well over time, yet smooth operation of the mechanism depends on the dimensional stability of the bushing and slider bar. While ingenious, the design is therefore prone to early failure in use. When first sold, interest in the Z-axis flex-head capability was high among mechanics.

Brown, in U.S. Pat. No. 4,748,872, describes a Z-axis flex ratchet wrench. The distal end of the motor driveshaft is joined to a foreshaft by a standard “universal joint” (a term of art synonymous with “U-joint”, “Cardan-Joint”, or “Hooke Joint”) with journal ed spider block characteristic of this class of joints. We see the spider block (U.S. Pat. No. 4,748,872 FIG. 3-4, element 100), in its conventional role of joining a precessing foreshaft to a driveshaft, each having an end-yoke, in universal driveshaft 70 of Sheet 1 of U.S. Pat. No. 4,748,872. The dual yokes and spider blocks of this construction are problematic from a manufacturing and maintenance standpoint.

Brown approaches the dual problems of a coaxial pivot plane in the joint and the uneven torque and rotational velocity of the u-joint in a unique way, stating “the spline gear 78 and the crankpin 114 will shift themselves longitudinally during rotation to keep the bores 102, 104 of the spider block 100 in registration with the axis defined by bores 34,36. Applicant believes that this longitudinal shifting is due to the principle of dynamics which holds that a body in motion tends to follow the path of least resistance, and since wobble is an unnatural balance condition, the driveshaft 70 will be longitudinally positioned during rotation to accept a position which for each particular circumstance is wobble free” (col 3). Note also spring-loaded washer plate 32 of FIG. 7 (U.S. Pat. No. 4,748,872) as is discussed in the Abstract to the Brown disclosure, where is stated, “the shaft is mounted in the tool in such a manner that the coplanar axes can float into alignment”. This teaching advances over earlier wrenches containing u-joints (Lund U.S. Pat. No. 1,975,695 and Cooley U.S. Pat. No. 2,499,569 for example). Thus, Brown recognizes in part the problems posed by uneven rotational velocity and coupling stresses associated with use of a Cardan u-joint, and offers a solution based on a slip joint with spring means. The dual yokes, spider blocks and spring mechanism of this construction are problematic from a manufacturing and maintenance standpoint.

Eyssallene, in U.S. Pat. No. 6,928,902, also describes a Z-axis flex wrench, while not using a ratchet mechanism, but again using a conventional Cardan-type universal joint as the pivot means (U.S. Pat. No. 6,928,902, FIG. 2, element 24). Here a cogwheel mechanism replaces the ratchet rocker dog. A pivot post and pivot lug ears are depicted in FIG. 5 (U.S. Pat. No. 6,928,902, FIG. 5, items 38, 14 and 44). The dual yokes and compound journal cross of this construction are problematic from a manufacturing and maintenance standpoint. Importantly, the driveshaft 20 must be configured to rotate both clockwise and counterclockwise by directional throw switch 30, a necessary feature in the design that is not required in a ratchet wrench.

In fact, the problem of transmitting torque from a driving shaft to a coupled driven shaft angled away from the long axis of the driving shaft is an old one, and the transmission couplings remain the subject of innovation. Spicer, in U.S. Pat. No. 919,651 describes what is essentially a ball with lateral pins extending from the ball into axial channels in a cylindrical housing joined to a second shaft, whereby the rotational motion of the ball is transmitted to rotational motion of the cylinder by means of pins as “intermediate members”, the pins fitted with flexible bearing boxes for engaging the channels. The rotational velocity and torque of “universal joints” in general characteristically fluctuates. We see “constant velocity u-joints” in U.S. Pat. No. 2,441,347 to Dodge, wherein the intermediate member is required to dynamically orient on a “homokinetic plane” bisecting the angle of pivot of the two shafts as the shaft coupling bends, by doing so eliminating the phase angle between driving and driven shaft, or substantially so. However, all true “constant velocity joints”, or “CV joints”, both plunge joints and non-telescoping variants thereof, are characteristically complex or require high precision, as exemplified by further improvements shown in US 2006/0240897 and US 2002/0042997, and are thus not well suited to small tools. Essentially, the “CV-joint” designs as shown in these patents and cumulatively in related art are not readily adapted for a palm-sized socket wrench. Thus while homokinetic rotation would be desirable, manufacturing simplicity and reliability must come first in this class of tools.

Innovation in “universal joints” has also continued. In reviewing U.S. Pat. No. 4,065,941 to Aoki, U.S. Pat. No. 4,188,801 to Hugh, U.S. Pat. No. 4,692,127 to Wagner, U.S. Pat. No. 4,936,701 to Allen, U.S. Pat. No. 5,851,151 to Reynolds, U.S. Pat. No. 6,152,826 to Profeta, U.S. Pat. Nos. 6,267,681 and 6,390,927 to Cleveland, and U.S. Pat. No. 6,869,366 to Delaney, we see incremental modifications and improvements. The listed inventions relate to a simple adaptor, generally for use on an impact wrench, that allows the head of the tool to be worked at an angle. Typically, a spring member is used to dampen axial displacements of the head and base of the adaptor, which could lead to binding or seizing of the head on the wristpin, apparently a similar problem to that described by Brown above, referencing remarks made by Brown concerning “registration”. Patentable variations are many. Aoki describes a captive wristpin with spring-mounted balls, Hugh describes a “quadrified ball” with impinging faces and spring-mounted bias member (element 5 of FIG. 1 of U.S. Pat. No. 4,188,801); Wagner describes a slip joint with spring element (element 19 of FIG. 1 of U.S. Pat. No. 4,692,127); Allen a “coil spring”; Reynolds a “plug tension washer” and “C”-spring (elements 62 and 68 of FIG. 3 of U.S. Pat. No. 5,851,151); Profeta a “resilent retaining means 16, such as a flat leaf spring”; Cleveland a prominent coil spring; and Delaney a “wave spring” (element 24 in FIG. 23 of U.S. Pat. No. 6,869,366). The need for the spring relates to the tendency of the joint to want to reposition itself as described by Brown and to prevent seizing or galling.

The more recent prior art work further teaches that the “pin and ball” joints, as represented by Dodge (U.S. Pat. No. 2,441,347), are subject to shearing off of a pin or pin at the ball or by neck failure of the ball. According to Delaney in U.S. Pat. No. 6,869,366, “Additionally, the bearing area where the pin contacts the slot within the ball becomes deformed because of the great amount of force and lack of material support” (Col 1, U.S. Pat. No. 6,869,366). It is also noted that the pin configuration of Hugh is subject to wear, which leads to binding, and that Profeta is limited in angular pivot, and so forth. The only general agreement in the cumulative prior art work of the last 100 years seems to be that a fully satisfactory solution to the problem has not been found.

Accordingly, there remains a need for an improvement of bendable head power tools with ratchet action that is simple to manufacture and reliable.

### SUMMARY OF THE INVENTION

As a mechanic, I have found that flexibility of a ratchet-action tool in the Z-axis is a great advantage in reaching fasteners or members positioned in narrow and hard to reach places. The prior art offers a range of teachings, and the only general agreement in that cumulative work seems to be that a fully satisfactory solution to the problem of transmitting torque to a small tool with a bendable head has not been found, and that difficulties continue. Although ratchet wrenches, unlike impact wrenches which must operate at very high speed and be reversible, operate at speeds of about 100 rpm and generally deliver torque of less than 100 foot-pounds, the split shafts of a bendable head ratchet tool can be subjected to axial forces as the head bends. Small longitudinal deviations of the coupling axis from the pivot axis increase these forces, as taught by Brown. Without relief, a miniature and inexpensive Cardin joint can wear excessively under these conditions and is not readily serviceable, likely necessitating field replacement of the entire split shaft at substantial cost. Similarly, spring means to oppose axial displacements are not durable. However, contrary to the teachings of Brown, the solution taught here is a coupling that opposes axial shifts of the shafts and may be assembled without tools, without adjustment, and without springs. The compact design disclosed here opposes axial forces by transferring them to suitable bearing surfaces, permits smooth transmission of rotational torque to the tool head during bending of the shafts, and is both rugged and simple to manufacture and maintain—thus succeeding where others have not.

Central to the design is a split shaft modified with a pivotable shaft coupling that pivots essentially coaxially with the pivot axis of the tool head; wherein the pivotable shaft coupling is a slotted ball and slotted-ball-receiving socket with wristpin, and the shafts are further modified with opposite ends configured for engaging a ratchet mechanism and tool motor. The slotted ball and slotted-ball-receiving socket are mated to form a bearing surface configured to dampen axial translation of the wristpin or slot in the coupling and to aid in assembly. The pivotable shaft coupling is assembled by merely dropping the foreshaft onto the driveshaft in place in the housing. Surprisingly simple—yet this design solves the bending head ratchet power tool problem without increasing the head size, and without the difficulties in manufacture and durability that have characterized the prior art.

Power is communicated from the motor driveshaft to the ratchet dog and pawl mechanism of the socket head via a pivoting foreshaft modified with an excentric crankpin for engaging the ratchet mechanism. The foreshaft is further modified at the proximal end to engage a pivotable shaft coupling to the driveshaft, the coupling a slotted ball and socketed wristpin which also serves as an axial bearing. The Z-pivot axis of the split shaft coupling and of the pivot “pins” or “posts” of the housing (where the head and body are hinged) are coaxial at all bending angles and self-aligning, with no need for a slip joint on the spline or a spring bias means in the coupling. The Z-pivot axis in this design is positioned at the base of a neck on the head, offering the advantage of a slender conventional ratchet head, and the nose of the motor body housing or the neck of the head can be extended so as to lengthen the reach of the tool, a further advantage.

In a preferred embodiment, a pair of lug ears on the head mate with machine flats or ears on the body or nose of the motor housing and are secured with pivot posts centered on the Z-axis pivot line. The pivot ears are sturdy, and join the head to the body, strengthening the neck and opposing the torque delivered to the workpiece so that the tool may also be used manually as a sort of spanner wrench.

Another benefit of the invention is simplicity in implementation, reducing the barriers to commercial success. Because the split, two-piece shaft with pivotable shaft coupling requires little or no modification of ratchet action mechanisms of the head of the tool or the motor, the invention may be used with any conventional ratchet action head and with any kind of motor (ie. with any prior art means for ratcheting and motor means). Means for engaging the motor include sun gear, star gear, spline gear, crown gear, pinion gear, cog gear, helical gear, worm gear, gear, belt, chain, impeller and direct drive. Means for engaging a ratchet mechanism comprise an excentric crankpin, typically fitted with a bushing. Motor means include pneumatic and electric motors, including cordless electric motor means.

The invention is suitable for Z-axis bendable head ratchet socket and box wrenches or screwdrivers, pneumatic and electric. A preferred embodiment is a bendable head power ratchet wrench. Other objects, features and advantages of the invention will become more apparent from the description of the invention in connection with the drawings to be described more fully hereinafter.

### BRIEF DESCRIPTION OF THE DRAWINGS

FIG. 1 is an exploded view of a preferred embodiment of the present invention, and shows a power socket wrench with Z-axis pivoting head with conventional ratcheting means generally indicated.

FIG. 2 is an elevation or side view of the assembled socket wrench with bendable head. The cut plane 3 of the longitudinal section of FIG. 3 is shown.

FIG. 3 shows a sectional view of a ratchet drive mechanism and the two-piece split shaft with pivotable shaft coupling.

FIGS. 4A and 4B are detailed views of the two-piece split shaft elements and pivotable shaft couplings joining a split shaft in two orientations. The slotted ball and wristpin construction of this coupling may be used in either orientation on the shaft elements.

FIG. 5 demonstrates the pivot action of the ratchet head on the nose of the motor body housing and position of details 6 and 7.

FIG. 6 shows a first embodiment of a detent, here a cutaway view of a spring-mounted detent ball impinging on the lower radius of the pivot ears. Mated detent ball-receiving concavities or “detent stops” in the rim of the ear hold the head at a fixed angle during setup for use of the tool.

FIG. 7 shows an alternate embodiment of a detent, here an exterior plan view marked with the cross-section plane 8 shown in FIG. 8.

FIG. 8 is a cross-section in plan view through a detent mechanism built into the pivot posts. The Z-axis of rotation of the ratchet head on the motor nose body is the dotted center line. This assembly is described further in the following FIGS. 9A and 9B, which correspond to elevation views taken at planes 9A and 9B.

FIGS. 9A and 9B represent the two ear members of the pivot assembly of FIG. 8. On the left, the ear or flat of the motor body nose is shown (FIG. 9A), and on the right, the ear or flat of the pivot yoke (FIG. 9B). A mechanism is described which permits the manufacturer to form sturdy multiple detent stops (clockwise-counterclockwise) for precision placement of the bendable head at a selected angle. The mechanism is explained in the detailed description to follow.

### DETAILED DESCRIPTION

Unless explicitly defined herein, words and phrases used here take their meaning as consistent with usage as would be apparent to one skilled in the relevant arts or, secondarily, by reference to a contemporaneous edition of Webster's unabridged English dictionary. When cited works are incorporated by reference, any meaning or definition of a word given in any incorporated reference that conflicts with or confounds the meaning as used here shall be considered idiosyncratic to said reference and not the meaning of the word as used in the present disclosure. The following definitions are provided to aid in an explanation of the invention.

A “fastener” or member refers to a hardware fitting such as a bolt, nut, or screw, and may also include specialty hardware members such as splines, studs, ring clamps, and threaded fittings such as oil filters, oxygen sensors and the like.

A “socket bit” is a detachable adaptor which may be secured via an interlocking male or female receiver on the socket bit retaining member of the tool head, when male sometimes called the “socket stud”, and which engages a fastener or member.

A “universal joint” is a term first reportedly coined by Henry Ford, and refers to Cardan, Hooke, and Hotchkiss joints, and is a common term of art. The joints are characterized by a double yoke system and a joining pair of crosspins at right angles to each other (see Brown U.S. Pat. No. 4,748,872 and Eyssallene U.S. Pat. No. 6,928,902). These joints are characterized by a surging and uneven rotational velocity and torque, the periodicity of which is determined by a complex trigonometric function of the pivot angle of the shaft and the axial rotation angle of the yokes and spider block or compound journal cross, which do not rotate in the homokinetic plane bisecting the angle formed by the bent shafts. Improvements continue to be made, however, in universal joints and in their applications.

“Pivotable shaft coupling” as claimed herein refers to a simple mechanism for pivotably joining a first and second shaft of a split shaft, and is comprised of three core elements: 1) a slotted ball with end “slot” or “jaw” on the end of a first shaft, 2) a slotted-ball receiving socket with “socket” or “cup” or “yoke” with “collar” or “jaws” on the end of a second shaft, and 3) a single interlocking wristpin, often a press “pin” of hardened steel or the like, which is held in the collar or jaws of the slotted-ball-receiving socket and impingingly engages the slot of the slotted ball. The slotted ball is configured to fit within the socket to form a modified ball-and-socket joint or partial ball-and-socket joint, with a “bearing” surface (as in “ball bearing”) that is lubricated, and thus the coupling is integral to an essentially continuous “mechanical stack” extending from rocker dog to motor, dampening or limiting axial motion of the two shafts. The center of rotation of the wristpin during operation of the motor is essentially co-axial with the Z-pivot axis or “hinge” connecting the tool's head and body. A nominal amount of play in the position of the foreshaft, as would be desired to permit smooth operation of the excentric crankpin and rocker dog, is permitted because the slot can slide in and out or up and down on the wristpin, but the slot cannot grab and seize the wristpin because it is held at a fixed minimum distance by the fit of the ball in the socket. Because the geometry of the coupling is fixed by the mated shape of the three core elements, the split shaft can be assembled simply by dropping the foreshaft into place on top of the driveshaft. Modern tool steels and suitable radii on the pieces make for durable couplings suitable for commercial use. A bevel or curvature on the slot is also contemplated. Note that the slot in the slotted-ball need not be bilaterally symmetrical because shaft rotation is not bidirectional. The coupling rotates smoothly without the need for a slip joint on either shaft or a spring biasing of the ball or shaft.

“Conventional” is a term designating that which is known in the prior art to which this invention relates, particularly that which is used and sold in the mechanic's trade. Patents cited herein are incorporated herein in their entirety by reference.

“About” and “generally” are expressions of inexactitude, describing a condition of being more or less, approximately, or almost, where variations would be insignificant, obvious, or of equivalent utility or function, and further indicating the existence of obvious minor exceptions to a norm, rule or limit.

Herein, where a “means for a function” is described, it should be understood that the scope of the invention is not limited to the mode or modes illustrated in the drawings alone, but also encompasses other means commonly known in the art at the time of filing and other means for performing the equivalent function that are described in this specification or cited as incorporated by reference.

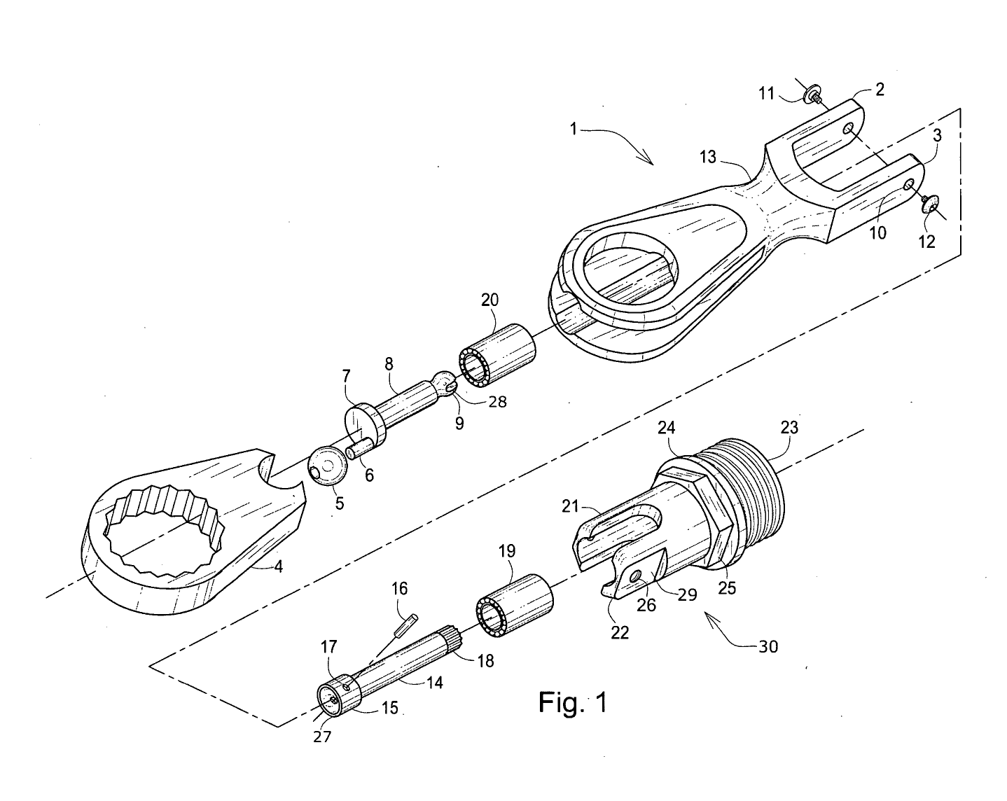

Turning now to the figures, FIG. 1 illustrates an exploded view of a bendable head ratchet wrench, a preferred embodiment of the invention. Illustrated is a ratchet head 1 modified with lug ears (2,3) and a motor body nose 30 modified with mating ears or flats (21,22). A motor body and motor is not shown, but such motor means as are known in the art may be fastened to the motor body nose at straight-threaded boss 23 and tightened down against flange 24 by use of wrench flats 25. Similarly, detailed operation of a ratchet mechanism with pawl or pawls is not shown here because it is known in the art. The improved design of the split shaft with pivotable shaft coupling illustrated here and in the following figures and description is simple and readily manufactured and repaired.

To flex, the ratchet head pivot yoke, made up of outside pivot ears (2,3), will pivot at pivot posts or “pins” (11,12). This is a Z-axis pivot-analogous to that of a hand on a wrist, where the hand is the ratchet head and the wrist is the motor body nose. The Z-pivot axis is defined by a line drawn through pivot holes 10, 26 and pivot posts (11,12), which are threaded or fastened to the motor body nose inside ears (21,22). Ears (2,3) on the neck of the head are mounted on mated machine flats 29 and ride on smooth shanks of pivot posts 11 and 12 for ease of pivoting. Optionally, inside pivot ears may be formed on the neck and mated with outside yoke ears on the motor body nose, yoke ears or combinations with mating machine flats serving an equivalent function as a hinge in various configurations as would be readily apparent to one skilled in the art.

Conventional ratchet head 1, shown here figuratively without full details of assembly, has a breadth and depth typical of conventional ratchet heads but the neck 13 may be lengthened or shortened as desired. Various conventional ratcheting mechanisms may be used in place of the one suggested here figuratively. The drawing is indicative, but makes no limiting selection of any one ratchet mechanism among all those known in the prior art.

The drive train is split into a driving driveshaft 14 and a driven foreshaft 8. The driveshaft 14 in this embodiment is typically provided with a sun gear 18 on the proximal end, which engages planetary reduction gears, not shown, in the motor body in a conventional way, but is not limited to such.

The driveshaft 14 drives foreshaft 8. The two shafts are coupled through slotted ball 9 and mating socket with wristpin 16. This pivotable coupling mechanism is now explained in more detail.

The driveshaft 14 is modified distally with a ball-receiving socket 15 and collar 27, through which wristpin 16 is press or shrink-fitted at cross-bore 17. The foreshaft 8 is modified at its distal end by milling or affixing endplate 7 and excentric crankpin 6, on which a ball or bushing 5 is mounted. The proximal end of foreshaft 8 is milled or turned to form slotted ball 9 with slot 28. The transmission works as follows: As ball 9 is inserted into socket 15, the slot 28 is engaged by wristpin 16 mounted in collar (“socket” or “yoke”) 27. As the driveshaft socket 15, collar 27 and pin 16, rotate axially as a unit, slotted ball 9 and foreshaft 8 must also turn as a unit. Importantly, when the foreshaft 8 is pivoted out of the long axis of rotation of the driveshaft, the two shafts continue to turn together and the slotted ball reseats on the wristpin. As the foreshaft is pivoted off axis and rotated, the lips of slot 28 will deflect under the wristpin 16 in the socket 15, and will slide over the wristpin, alternating the end facet of the slot in contact with the wristpin, once per revolution. There is no slippage in rotation, however, because the lips of the slot continuously engage the wristpin. This motion continues, the ball remaining engaged with the wristpin through each revolution. Because the shafts are positionally restrained, no lateral motion of the shafts is permitted, and by making the slot deep enough so that the wristpin does not contact its trough, rotational interference is avoided. Limited slip of the pin in the ball is permitted without constraint and without need for a spring dampening means. This assembly is termed a “pivotable shaft coupling” and will be described further in the figures. By tapering the waist of the ball, impingement of the foreshaft against the lip of the collar of the socket during flexion of the head is prevented in a range up to a useful angular pivot of the shafts, and further pivot may be resisted mechanically by chucks or chuck blocks.

In the ratchet mechanism illustrated in part here, the distal foreshaft drives a conventional annular-geared ratchet dog or “rocker” 4 via ratchet dog “bushing” or “ball” 5 and excentric crankpin 6. A pawl mechanism, for example, may be engaged by the ratchet dog to transform the seesaw rocking motion of the ratchet dog to unirotational motion of a socket stud upon which a socket bit is mounted, as would be known to one skilled in the art. Note that the driveshaft rotation is not required to be reversible, but ratchet stud rotation is necessarily reversible, the mechanisms of such devices being readily known to those skilled in the arts.

Bushings 19 and 20 shown in the figure are used to stabilize rotation of the two shafts 8 and 14 and may be lubricated, for example, by dipping the head of the tool into machine oil and wiping off the excess. Needle bearing sleeve bushings are shown, as preferred for their superior friction-reducing performance, but solid bushings or slip fitting shafts may also be used to reduce unit cost of manufacture. In a preferred embodiment, the elements of the head are dimensioned proportionately so that shafts and bushings drop down into the motor body through ratchet head 1 and stack. By nesting internal diameters from lesser to greater in the stack, the parts will rest on supporting flanges at each stage of assembly. The pivotable shaft coupling can be assembled simply by dropping the foreshaft subassembly onto the driveshaft in place in the housing. Thus bearing sleeve 20 may be larger in diameter than bearing sleeve 19, and so forth. An alternate assembly involves simply mating up fully assembled ratchet head and fully assembled motor body subassemblies and bolting on the pivot pins. When fully assembled, the mechanical stack from ratchet dog to motor has nominal axial (longitudinal) translation (displacement), and optional restraining flanges or bushings may also be incorporated. Accessory bearings contemplated include roller thrust bearings, tapered bearings, self aligning bearings, needle bearing sleeves, ball bearing sleeves, split sleeve bearings, pin bearings, axle butt bearings, with supporting flanges, grooves, races and lands, and the like, as suitable to eliminate sources of friction or instability during use.

For the coupling transmission to operate smoothly and reliably through the broadest possible range of flexion, the pivot axis of the pivotable shaft coupling must be essentially coaxial with the centerline of the Z-pivot axis through the ears. The Z-axis pivot line of the transmission coupling between driveshaft 14 and foreshaft 8 is defined by the position of wristpin 16 and cross-bores 17, not by the slot, which is dimensioned to allow some play. Slot 28 is dimensioned to accommodate wristpin 16 with acceptable play and clearances as would be required for free rotation over the range of head bending allowable and is shaped to mate with the socket or yoke 15. The center of rotation of the wristpin during operation of the motor is positioned at a point or level essentially coaxial with said Z-pivot axis, that point being essentially independent of the pivot angle of the ratchet head on the motor body nose; and moreover, the wristpin is not allowed to bottom out in the trough of the slot. The wristpin is held in the mechanical stack at a relatively constant depth D′ as measured on the long axis centerline of the axis of rotation of the ball, that depth D′ being essentially independent of the pivot angle of the ratchet head on the motor body nose. The slot may be further shaped to improve the pressure angle of the wristpin on the contacting facets of the slot.

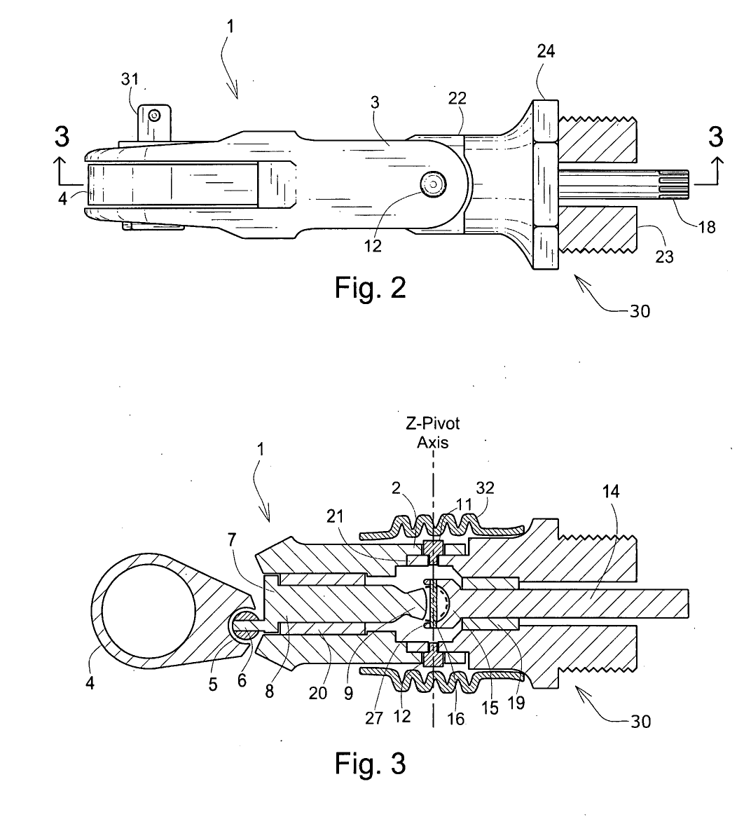

FIG. 2 is a side or “elevation” view of a pivotable shaft coupling assembly enclosed within the tool housing. Shown in this view simply to orient the viewer is the socket bit stud 31 in ratchet head assembly 1. In this embodiment, ear 3 of the head is mounted on pivot post 12, which is threaded into ear 22 of the motor body nose 30. Flange 24 is machined with wrench flats if desired. Boss 23 is preferable straight-threaded, but optionally, the motor body nose is of single piece construction with the motor housing. Rigidity of the head, neck, and nose is desirable if the tool is to be used as a spanner wrench, and the sturdiness of this model as a lever is apparent in the figure. FIG. 2 is also shown so that the section plane 3 of FIG. 3 is clearly marked.

FIG. 3 is a sectional view of a preferred tool embodiment. Ratchet head assembly 1 is joined to motor body nose 30 by mated ears (2 and 21 are marked) and pivot posts (11,12). Ratchet dog 4 is part of the ratchet assembly that drives socket bit stud 31 (above), and is of conventional means for ratcheting. Also shown of the ratcheting mechanism are bushing 5, excentric crankpin 6, and endplate 7. Foreshaft 8 is mounted in the head with sleeve bushing 20. The slotted ball 9 at the proximal end of foreshaft 8 is sectioned to show the taper at the base of the ball and rounded shoulders at the base or trough of the slot (see also 28, FIG. 1). Resting in but not touching the trough of the slot is wristpin 16, which is secured in socket 15 through cross-bores in collar 27. Depicted with a dotted line are the lips of the slotted ball engaging the wristpin and mated to the socket 15.

In this embodiment, a single-piece construction of the driveshaft 14 with socket 15 and sun gear (18 of FIG. 2) is shown. Bushing 19 aligns the driveshaft with the motor housing nose. The Z-pivot axis (center dashed line marked as such) intersects ear pivot posts 11 and 12 and wristpin 16. The head may be pivoted while the tool is in use or an angle may be preselected before the tool is applied to the workpiece.

Note the nested construction, whereby bushing 19 rests against a flange in the body, and is smaller in diameter than bushing 20, which rests against a flange in the neck of the head. The shafts and bushings of this embodiment are designed so as slide into the housing and stack during assembly without tools or adjustment. The mechanical stack allows a nominal amount of axial play and is held in place by the ratchet dog (4) yoke or anvil and bushing 5. To resist lateral forces, the shafts are optionally supported on mated machined bores, flats, or bushing sleeves in the housing, or on ball or needle bearing races where necessary for smooth rotation of any shaft as would be known in the art. Dustboot 32 is provided as an option.

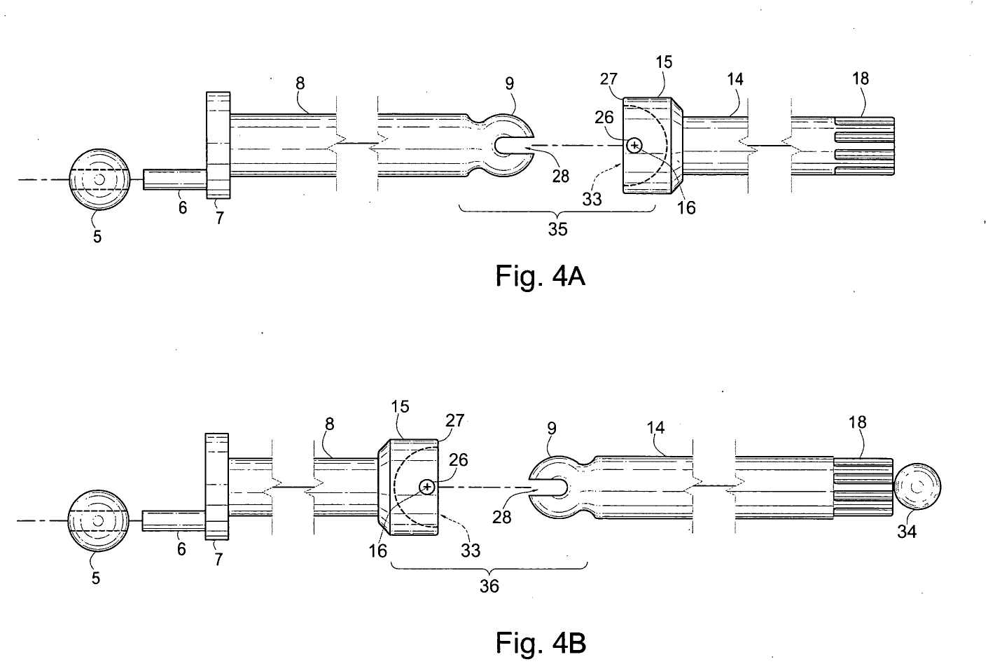

FIG. 4A shows in more detail the simple construction of a preferred embodiment of the pivotable shaft coupling 35. On the left is foreshaft 8; on the right driveshaft 14. The foreshaft 8 is machined with distal end elements adapted for driving the ratchet means. As illustrated here, bushing 5 mounts on excentric crankpin 6, which is milled or affixed off-center to the end or headplate 7 of the foreshaft. The proximal end of the foreshaft is turned or milled to form a ball 9, which is then slotted at 28. The driveshaft 14 (the lengths of both shafts may be adjusted) is machined with cup 33 in socket 15, collar 27, cross-bore 26, and fitted with wristpin 16. The cup 33 (dotted line) is mated to the ball 9, forming a bearing surface, which may be lubricated with permanent surface treatments such as Chevron's open gear lubricants and high film strength greases (Chevron Inc, San Ramon Calif.). Any modified yoke fitted to the ball may be used instead of a literal ‘cup’. The proximal end of the driveshaft (facing the motor) is shown here as a sun gear 18.

For assembly, ball 9 and slot 28 are simply fitted onto wristpin 16 and into socket 15. Once in place and mounted in the housing, the lips of ball 9 are free to deflect under wristpin 16 when foreshaft 8 is bent out of the axis of rotation of the driveshaft. As can be seen, however, the slot 28 retains its contact with the wristpin, and rotates with the driveshaft. At larger bending angles of the head, the slot slips smoothly from one end facet to the other on the wristpin once per revolution.

Pivotable shaft coupling assembly 35 comprises slotted ball 9 and slot 28 of a first shaft, and wristpin 16, crossbore 26, collar 27, and socket 15 of a second shaft. In this embodiment, socket 15 is positioned distally (away from the motor) on the driveshaft, and slotted ball 9 proximally (toward the motor) on the foreshaft, but there is no reason why the orientation cannot be switched: socket 15 may be positioned proximally on the foreshaft, and ball 9 distally on the driveshaft as shown in FIG. 4B.

The foreshaft 8 and ball 9 in a preferred embodiment is steel or titanium with machined and tempered slot that fits over a hardened steel or titanium press pin 16, thus forming a slotted-ball-and-socket joint, here termed a “pivotable shaft coupling”. The shafts can be termed “driving shaft” and “driven shaft”, or if preferred, “first shaft” and “second shaft” generically, or because the motion is relative.

In FIG. 4B, foreshaft 8 and driveshaft 14 are again shown, but the components of the pivotable shaft coupling 36 are re-oriented, specifically they are flipped horizontally. The components of the sub-assembly are numbered exactly as described for FIG. 4A in order to better point out their equivalence. Note however, in this embodiment, that the foreshaft 8 is bounded at both ends by internal flanges and that the driveshaft 14 is shown without flanges. Means for registering a shaft without flanges include the axial butt bearing 33 shown here. Means for assembling the foreshaft of FIG. 4B with bushing and housing are also conceived, for example with split bearings.

Socket 51 and foreshaft 8 are readily replaceable for servicing, and may be made of tool steel, tungsten alloy, carbide, or silicon nitride. Although not shown as such in the drawings, endplate 7, excentric crankpin 6, and slotted ball 9 are optionally not made by single-piece machining with the foreshaft. Again, particularly because shaft rotation is unidirectional, subassemblies comprising the foreshaft with excentric crankpin and slotted ball can be designed so that less machineable or more expensive materials can be used for high-wear parts such as the slotted ball. Ceramic enamels or faces may also be applied. Subassemblies may be threaded, pinned or otherwise bonded.

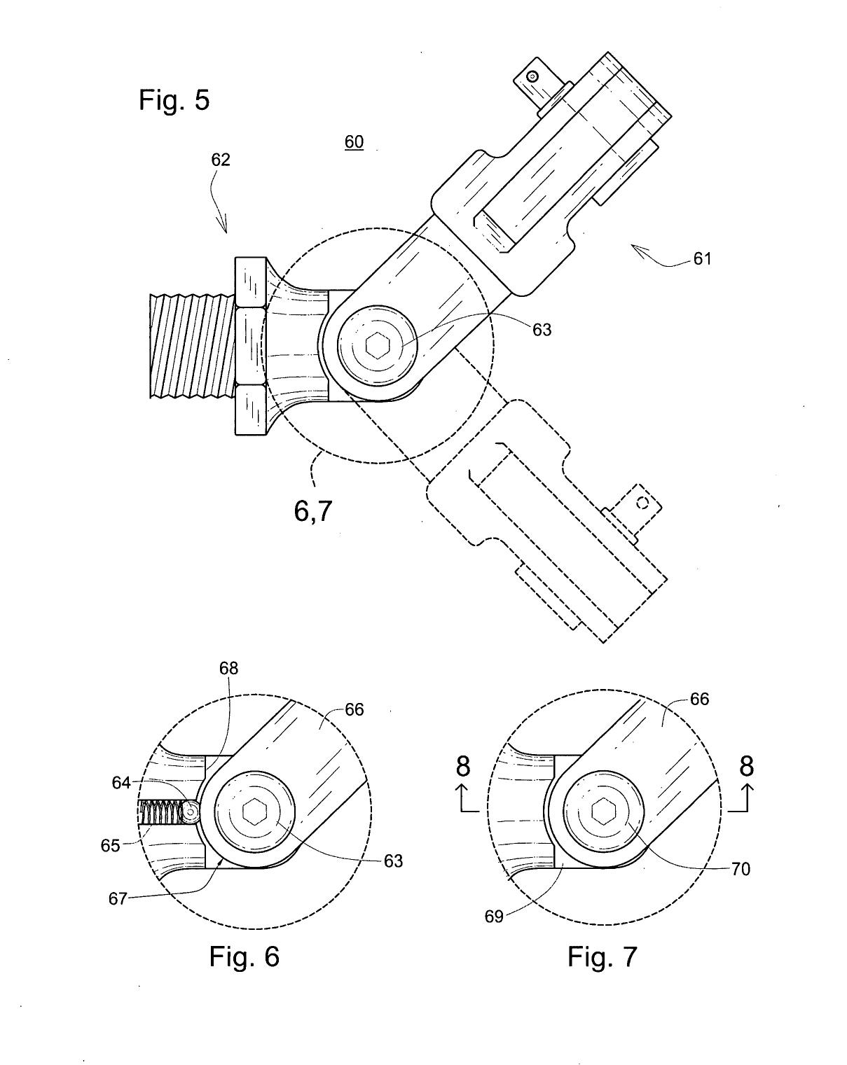

In FIG. 5, bendable ratchet wrench with pivotable shaft coupling 60 is shown having ratchet head 61 in an up and down position (a Z-axis pivot) on tool body nose 62. The head pivots at pivot post 63. Pivot post 63 is provided with an Allen head in this example. Circled is an aspect of the tool relating to the incorporation of a detent assembly and pivot post construction so that the tool will remain stationary at a pivot angle pre-selected by the user, and as described in detailed views 6,7 as follows.

FIG. 6 is detail showing an embodiment of a first detent mechanism. Detent ball (64), bullet or pin is spring-mounted (65) in a blind bore (shown in cutaway) in the motor nose housing 62 and will springedly press up to “click-lock” engage a mated detent concavity on the leading edge of the head pivot ear (66), which is radiused 67 over a selected distance from the machined flat 68 in the nose. Using this mechanism, the ratchet head can be bent or pivoted and locked in place at variable angles +X or −X, for example at about 15°, 30°, and 45° up or down on the Z-axis pivot line running through ear 66 on the center axis of pivot post 63. The radii on the ears may be further machined with chuckstops to prevent excessive pivot of the head; alternatively, a pin may be machined on the inside face of the ears, and mated to a slot on the corresponding other ear or flat so as to limit pivot to a selected range and not pinching.

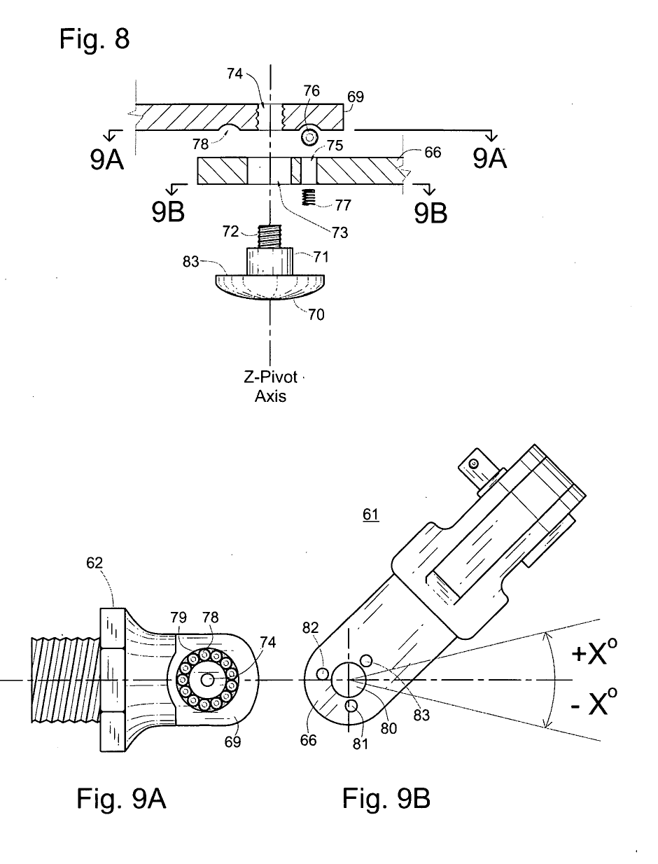

FIG. 7 is a side view of an alternate detent mechanism with modified pivot screw 70 and sectional plane 8 from which FIG. 8 is derived. Head ear 66 and nose ear 69 with flat are identified. In the exploded sectional view of FIG. 8, pivot screw or post 70 is a compound screw with broad Allen head, underside face 89 for retaining spring 77, shank 71 with smooth bearing surface for contacting head ear 66 in bore 73, and with threaded stud 72 for tightening into ear 69 at threaded pivot hole 74. Ear 66 is also drilled at 75 for installation of a detent subassembly comprising detent ball 76 and spring 77, which may be a coiled spring, a “C”-spring, a “finger” spring, a “leaf” spring, or other spring biasing means such as an elastomeric plug. Detent ball 76 can rest in one or more concavities or “detent stops” 78, locking the mechanism in place yet permitting easy readjustment to another angle. Here the detent mechanism is part of the pivot subassembly. Note that the position of all holes and detent stops are identified by a radius from the common Z-pivot axis and by an angle from normal. The pivot hole radius RI will be smaller than the detent stop radius R2. The detent stop radius R2 and the radius of the detent holes R2 for the detent subassemblies will be equal. The ears themselves are typically formed by cutting an end face radius on the end of the ear, and this arcuate end face has a radius R3 greater than R2. The head of pivot screw 70 is necessarily of a radius R4 greater than the radius of the detent holes, and is generally less than radius R3. Selection of an angle +X or −X with this detent mechanism is discussed in reference to coronal sections 9A and 9B identified in FIG. 8.

FIG. 9A is representative of side view at section 9A of FIG. 8. The view is of the motor body nose 62 looking down at the outside surface of the flat of nose ear 69. A second such ear, oppositely facing, rests behind this plane. On the flat 69, multiple concavities or detent stops 78, are positioned within circular detent track or array 79 around pivot hole 74. Pivot hole 74 is threaded for tightening down pivot screw (“post”) 70 shown in FIG. 8, typically with an Allen wrench. Loctite® or other locking means may be used to secure the pivot screw for extended periods of use.

Each detent stop 78 on the radius of circular detent track 79 seats one detent ball, of which detent ball 76 of FIG. 8 is representative. The detent stop concavities 78 as shown are spaced so as to not overlap. However, the number of detent stop concavities may be increased so that the individual detent stops 78 partially overlap. By accident of the illustrator, 13 detent stops 78 are shown in FIG. 9A, dividing circular detent track 79 into roughly 27° divisions of arc. However, 12 such positions were intended in the sketch, with 30° divisions of arc. If 24 partially overlapping detent stops were so placed, 15° divisions of arc would be obtained. If 36 partially overlapping detent stops were so placed, divisions of 10° of arc would be obtained. If 60 partially overlapping detent stops were so placed, 6° divisions of arc would be obtained, and so forth.

FIG. 9B is taken from section 9B of FIG. 8. The view is of the head 61 looking down at the outside face of head ear 66. In addition to center bore 80, which rides on shank 71 of pivot screw 70 (see FIG. 8) and is not threaded, the ear is drilled out at three off-center bores 81, 82 and 83 intended for accepting three detent subassemblies (comprising detent ball 76 and spring means 79 of FIG. 8). Three such detent subassemblies are indicated here, but the number may range from 1 to 12 as desired. In one embodiment, the balls are positioned at the vertices of an equilateral triangle, so that all balls fall into detent positions simultaneously and thus act cooperatively as a detent. Note that by overlapping the detent stop semi-spherical depressions as described above and using three such balls, triply-detent tool positions at +X°=0°, 6°, 12°, 18°, 24°, 30°, 36°, 42°, and 48°, for example, may be obtained (and similarly for −X angles). Alternatively, the number of detent subassemblies can be increased to five. In another embodiment, six detent subassemblies are not positioned at equal degrees of arc around the centerhole, and are instead staggered as cross-axial pairs, with the pairs 0°, 5° and 10° out of phase. If three such pairs of detent balls are mated with thirty-six detent stops, the total number of rest positions is 108, providing detent stop positions at about every 3.3° of pivot. Numerous combinations are possible. In this way, more finely divided detent positions can be set and held while the tool is positioned on the workpiece. Assembly is not difficult because the parts in each detent subassembly are identical.

Optionally, a single detent ball 76 may be used, although it would not be useful to form detent stops 78 at angles the detent ball cannot reach. The detent mechanism may be bilateral, as part of both right and left pivot screws and ears, or unilateral, but when used bilaterally, the detent action is cooperative and firmer. Multiple detent balls are preferred, for example 3 detent balls placed equilaterally, or 6 detent balls placed as pairs contralaterally at staggered angles.

The optional “click-lock” detent feature is convenient for working in tight spaces where a straight line on the nut or bolt is not available and the tool can be set at an angle and then positioned on the fitting. It also allows the user to steady the tool before actuating power. Bending the head can be performed on the fly. The Z-axis bending head can also be used with straight shank or cable-flex extensions mounted on the socket bit stud to reach further into a machine around, or between obstructions, than a conventional socket tool allows, and also is stiff and strong enough to be used to torque fasteners manually with the power off. Its bendable head behavior is natural for the user because it bends the same way a human wrist and elbow does, and is the preferred embodiment, although y-axis bending heads of analogous design are contemplated.

Broadly embodied, the invention is a power ratchet tool comprising a pivotable head and motor body wherein power is transmitted from motor to a socket head stud by a pivoting split two-piece shaft further comprising a “pivotable shaft coupling” as defined herein.

The split shaft drive or “power train” embodiments of FIGS. 4A and 4B are particular embodiments of a pivotable shaft coupling of the inventive device. As assembled, the slotted ball and slotted-ball-receiving cup form a bearing surface and are generally treated with a surface lubricant. In some embodiments, a full cup is not used, and the bearing surface is formed by a partial contact between ball and socket. The figure shows clearly how the pivotable shaft coupling is surprisingly assembled without tools.

In another embodiment, the bendable head ratchet tool comprises a motor body with motor and motor body nose, a ratchet head with ratchet mechanism and with neck, and a pair of pivot posts joining the ratchet head neck to the motor body nose, thereby forming a Z-pivot axis on which the ratchet head pivots over a range of angles on the motor body nose. Power is transmitted by a two-piece split shaft drive from the motor to the ratchet mechanism, the split shaft comprising a driveshaft with proximal end and distal end, the proximal end with means for engaging the motor, a foreshaft with proximal end and distal end, the distal end with excentric crankpin means for engaging the ratchet mechanism, and a pivotable shaft coupling that joins the driveshaft to the foreshaft. The pivotable shaft coupling is comprised of a slotted ball with ball and slot, a slotted-ball-receiving socket with collar (the meaning of “socket” and “collar” taken broadly to include various yokes formed with bearing surfaces), and a single wristpin, wherein the wristpin is fitted through the collar or jaw so as to impingingly engage the slot of the slotted ball at all rotational positions of the driveshaft; the center of rotation of the wristpin during operation of the motor being positioned at a point lying on the Z-pivot axis (transaxial centerline of the hinge), that point being essentially constant and independent of the pivot angle of the ratchet head on the motor body nose. The wristpin of the pivotable shaft coupling impingingly engages the slot of the slotted ball at a depth in the slot as measured on the centerline of the long axis of rotation of the ball, that depth being essentially constant and independent of the pivot angle of the ratchet head on the motor body nose.

In a preferred embodiment, the slotted ball and slotted-ball-receiving socket are in contact and form a bearing surface at their interface. The bearing surface is configured to reduce or dampen axial translation of the wristpin in the pivotable shaft coupling. The bearing surface may be generally or partially hemispherical. This pivotable shaft coupling is thus distinguished from coupling joints comprising a spider block or journal cross, and from coupling joints or shafts comprising a spring or slip joint.

In a first embodiment of the pivotable shaft coupling, the pivotable shaft coupling comprises a foreshaft with distal end with excentric crankpin and proximal end with slotted ball with slot, a driveshaft with distal end with slotted-ball-receiving socket with collar and proximal end with means for engaging the motor, and a wristpin mounted in said slotted-ball-receiving socket.

In a second embodiment of the pivotable shaft coupling, the pivotable shaft coupling comprises a foreshaft with distal end with excentric crankpin and proximal end with slotted-ball-receiving socket with collar, a driveshaft with distal end with slotted ball with slot and proximal end with means for engaging the motor, and a wristpin mounted in said slotted-ball-receiving socket.

Thus the invention has another embodiment as follows: A bendable head ratchet tool comprising a split shaft drive with foreshaft and driveshaft, the foreshaft with distal end with excentric crankpin for engaging a ratchet mechanism and proximal end with slotted ball with slot, the driveshaft with distal end with slotted-ball-receiving socket with collar and proximal end with means for engaging a motor, and further comprising a wristpin mounted in the collar of the slotted-ball-receiving socket and configured to engage the slot of the slotted ball, thereby transmitting any rotary motion of the driveshaft to the foreshaft. A preferred embodiment is a bendable head ratchet tool of this paragraph, wherein the slotted ball and the slotted-ball-receiving socket form a bearing surface.

Alternatively, the invention is a bendable head ratchet tool comprising a split shaft with foreshaft and driveshaft, said foreshaft with distal end with excentric crankpin for engaging a ratchet mechanism and proximal end with slotted-ball-receiving socket with collar, said driveshaft with distal end with slotted ball with slot and proximal end with means for engaging a motor, and further comprising a wristpin mounted in the collar of the slotted-ball-receiving socket and configured to engage said slot of the slotted ball, thereby transmitting any rotary motion of the driveshaft to the foreshaft. A preferred embodiment is a bendable head ratchet tool of this paragraph, wherein the slotted ball and the slotted-ball-receiving socket form a bearing surface.

The various embodiments include combinations not shown in the drawings. Improved power sources may be substituted without alteration of the split shaft drive with pivotable shaft coupling. Improved ratchet heads may be substituted without alteration of the split shaft drive with pivotable shaft coupling. Details of construction of the body may be changed, yet the split shaft drive and pivotable shaft coupling need not be altered. Note that the position of ears and mating flats on the nose and neck of the head and body assembly are reversible, and the motor body may form ears and the head neck may form mating flats. Ears may be formed on both body and neck while retaining functional equivalence. Thus the terms “flat”, “mating flats” and “machine flat” forming a pivot surface can refer to an “ear” and are defined herein as inclusive of same, as would be readily recognized by one skilled in mechanics. The outside pivot ears for example, may be placed instead on the motor body nose with pivot posts affixed to machine flats on the ratchet head nose, reversing the construction of the tool as drawn here, but remaining functionally equivalent. Digital instrumentation may be added to either the motor body or head of the tool. The motor may be an electric motor or a pneumatic motor. Pivot rivets may be used in place of pivot pins, screws or posts. Adjustable retaining pins may be used in place of chuck blocks. Detent bullets or pins maybe used in place of detent balls. Materials may be substituted, and so forth, without departing from the scope of the invention and its claims.

Two detent means are illustrated as combinations with the bendable head tool. In the first, the neck of the ratchet head forms a yoke with right and left lug ears, the two lug ears drilled through with a pivot axis hole centered on the Z-pivot axis. The pivot axis hole has a radius R1, and the lug ears have an outside face, inside face, and arcuate end surface at radius R2 from the Z-pivot axis, meaning that their ends are shaped to form a part of a circle, as suggested in FIG. 6, element 67. The nose of the motor body is formed with first and second mated machine flats for receiving the two lug ears and with pivot holes centered on the Z-pivot axis for fastening the lug ears with right and left pivot posts, so that the first lug ear inside face contacts the first mated machine face and the second lug ear inside face contacts the second mated machine face. The detent mechanism comprises a spring-loaded detent ball countersunk into the motor body nose, again as shown in FIG. 6, the detent ball contacting the arcuate end surface of the first lug ear, the arcuate end surface of the lug ear having been formed with shallow concavities, the shallow concavities serving as “detent stops” whereby the detent ball is springedly arrested. By placing a similar detent pivot assembly under both right and left pivot ears, substantial firmness of placement is achieved. The head may be pivoted while the tool is in use or an angle may be preselected before the tool is applied to the workpiece.

In the second detent mechanism illustrated, the Z-pivot axis pivot mechanism comprises the pivot pin, a spring-loaded detent subassembly in detent subassembly holes drilled through an ear, and detent stops formed on a mated machine flat under the ear. More formally, the neck of the ratchet head is comprised of a yoke with pivot axis hole through first and second lug ears at the Z-pivot axis, the Z-pivot axis with centerline, the pivot axis hole with radius R1 from the centerline; and further the lug ears with outside face and inside face, and wherein the motor body nose is comprised of first and second mated machine flats configured with pivot holes centered on the Z-pivot axis for receiving and fastening the lug ears by the pair of pivot posts, so that the first lug ear inside face contacts the first mated machine face and the second lug ear inside flat contacts the second mated machine flat; and the pivot assembly further comprising a detent mechanism. The detent mechanism comprises at least one shallow concavity configured as a detent stop within the surface of the first machine flat of the motor body nose, said concavity at a detent stop radius R2 from the centerline, the detent stop radius R2 being greater then the pivot axis hole radius RI, and a detent subassembly hole through the first lug ear at the detent stop radius R2, and a detent ball and spring bias means mounted in the detent subassembly hole, so that the ball is compressed against the first machine flat of the motor body nose by the spring bias means, and a pivot post with head with head underside face configured to retain the spring in the detent subassembly hole. In this way, when the ratchet head is pivoted on the motor body nose so that the detent subassembly hole in the ear lines up with the detent stop on the machine flat, the detent ball is springedly arrested in the detent stop.

Note that this detent mechanism is also inventive. Therefore, another embodiment of the invention is a bendable head power ratchet tool comprising an outside yoke with first and second lug ears, the two lug ears with pivot axis hole centered on a Z-pivot axis with pivot centerline, the pivot axis hole with radius R1 from the centerline, and said lug ears with outside face and inside face, and an inside yoke with first and second mated machine flats for receiving the two lug ears of the outside yoke and with pivot holes on the pivot centerline for fastening the lug ears with a pair of pivot posts, so that the first lug ear inside face contacts the first mated machine flat and the second lug ear inside face contacts the second mated machine flat, and further comprising a detent mechanism as follows. The detent mechanism comprises at least one shallow concavity configured as a detent stop on the surface of the first machine flat of the motor body nose, said concavity at a detent stop radius R2 from the pivot centerline, the detent stop radius R2 being greater then the pivot axis hole radius R1, and a detent subassembly hole through the first lug ear at the detent stop radius R2, and a detent subassembly comprising a detent ball and spring bias means mounted in the detent subassembly hole, so that the ball is compressed against the first machine flat of the motor body nose by the spring bias means, and a pivot post with head with head underside face configured to retain the spring in the detent subassembly hole. From this structural recitation, it follows that when the ratchet head is pivoted on the motor body nose so that the detent subassembly hole lines up with the detent stop, the detent ball will be springedly arrested in the detent stop. Clearly, multiple such detent stops and detent ball subassemblies may be positioned concentrically around the pivot centerline as a circular array or track (as in FIG. 9A), thus permitting fine control of head angle. The plurality of detent stops and detent subassemblies in a concentric array at the detent stop radius R2 around the pivot centerline is held in place by the pivot post or pin, typically threaded into the hole in the machine flat of the nose.

This post or pin characteristically has a broad head and head underside face for this purpose and may be an allen bolt, slotted screw, or hex bolt, and the like, and will typically have smooth shanks as shown in FIG. 8, element 71. The pivot post head undersurface secures the spring in its hole, which in turn biases the detent ball, which in turn will “click lock” into a detent stop on the machined flat of the inside face between the ear and motor body nose when the detent subassembly hole and the detent stop line up. By placing a similar detent mechanism under both right and left pivot ears, substantial firmness of placement is achieved. As discussed with respect to FIGS. 9A and 9B, multiple such detent subassemblies will work cooperatively to set and secure the angle of the tool head.

Although the present invention has been described with reference to preferred embodiments, those skilled in the art will recognize that changes may be made in form, means and detail which are equivalent, and may be made without departing from the spirit, scope and claims of the invention.

I claim:

1. A bendable head ratchet tool, comprising:
a) a motor body with motor and motor body nose, a ratchet head with ratchet mechanism and with neck, and a pair of pivot posts joining the ratchet head neck to the motor body nose, thereby forming a Z-pivot axis on which the ratchet head pivots at more than one angle on the motor body nose; and,
b) a split shaft for transmitting power from the motor to the ratchet mechanism, further comprising a driveshaft with proximal end and distal end, said proximal end with means for engaging the motor, a foreshaft with proximal end and distal end, said distal end with excentric crankpin means for engaging the ratchet mechanism, and a pivotable shaft coupling that joins the driveshaft to the foreshaft; and,
c) further wherein said pivotable shaft coupling is comprised of a slotted ball with ball and slot, a slotted-ball-receiving socket with collar, and a single wristpin, wherein the wristpin is fitted in the collar so as to impingingly engage the slot of the slotted ball at all rotational positions of the driveshaft; the center of rotation of the wristpin during operation of the motor being positioned at a point lying on the Z-pivot axis, said point being essentially constant and independent of the pivot angle of the ratchet head on the motor body nose; and,
d) further wherein the wristpin of said pivotable shaft coupling impingingly engages the slot of the slotted ball at a depth in the slot as measured on the centerline of the axis of rotation of the ball, said depth being essentially constant and independent of the pivot angle of the ratchet head on the motor body nose; and,
e) further wherein the slotted ball and slotted-ball-receiving socket contactingly interface to form a bearing surface.

2. A bendable head ratchet tool of claim 1, wherein the motor is an electric motor or a pneumatic motor.

3. A bendable head ratchet tool of claim 1, further wherein said means for engaging the motor is selected from the group consisting of sun gear, star gear, spline gear, crown gear, pinion gear, cog gear, helical gear, worm gear, gear, belt, chain, impeller, and direct drive.

4. A bendable head ratchet tool of claim 1, further wherein said means for engaging the ratchet mechanism comprises an excentric crankpin on the distal end of the foreshaft.

5. A bendable head ratchet tool of claim 1, wherein said pivotable shaft coupling further comprises a foreshaft with distal end with excentric crankpin and proximal end with slotted ball with slot, a driveshaft with distal end with slotted-ball-receiving socket and proximal end with means for engaging the motor, and a wristpin mounted in the slotted-ball-receiving socket.

6. A bendable head ratchet tool of claim 1, wherein said pivotable shaft coupling further comprises a foreshaft with distal end with excentric crankpin and proximal end with slotted-ball-receiving socket, a driveshaft with distal end with slotted ball with slot and proximal end with means for engaging the motor, and a wristpin mounted in the slotted-ball-receiving socket.

7. A bendable head ratchet tool comprising:
a) a split shaft drive with foreshaft and driveshaft, said foreshaft with distal end with excentric crankpin for engaging a ratchet mechanism and proximal end with slotted ball with slot, said driveshaft with distal end with slotted-ball-receiving socket with collar and proximal end with means for engaging a motor; and,
b) and further comprising a wristpin mounted in the collar of the slotted-ball-receiving socket and configured to engage the slot of the slotted ball, thereby transmitting any rotary motion of the driveshaft to the foreshaft; and,
c) further wherein the slotted ball and the slotted-ball-receiving socket contactingly interface to form a bearing surface.

8. A bendable head ratchet tool comprising:
a) a split shaft drive with foreshaft and driveshaft, said foreshaft with distal end with excentric crankpin for engaging a ratchet mechanism and proximal end with slotted-ball-receiving socket with collar, said driveshaft with distal end with slotted ball with slot and proximal end with means for engaging a motor; and,
b) further comprising a wristpin mounted in the collar of the slotted-ball-receiving socket and configured to engage said slot of the slotted ball, thereby transmitting any rotary motion of the driveshaft to the foreshaft; and,
c) further wherein the slotted ball and the slotted-ball-receiving socket contactingly interface to form a bearing surface.

9. A bendable head ratchet tool of claim 1, further comprising:
a) a pivot assembly wherein the neck of the ratchet head is comprised of a yoke with pivot axis hole through first and second lug ears at the Z-pivot axis, the Z-pivot axis with centerline, the pivot axis hole with radius RI from the centerline; and further the lug ears with outside face, inside face, and arcuate end surface at radius R2 from the centerline, where radius R2 is greater than radius R1; and,
b) wherein the motor body nose is comprised of first and second mated machine flats configured with pivot holes centered on the Z-pivot axis for receiving and fastening the lug ears by the pair of pivot posts, so that the first lug ear inside face contacts the first mated machine face and the second lug ear inside flat contacts the second mated machine flat; and,
c) said pivot assembly further comprising a detent mechanism, wherein the detent mechanism comprises a spring-loaded detent ball countersunk into the motor body nose, the detent ball contacting the arcuate end surface of the first lug ear, said arcuate end surface further comprising one or more shallow concavities, wherein the shallow concavities are configured as detent stops, whereby the detent ball is springedly arrested.

10. A bendable head ratchet tool of claim 1, further comprising:
a) a pivot assembly wherein the neck of the ratchet head is comprised of a yoke with pivot axis hole through first and second lug ears at the Z-pivot axis, the Z-pivot axis with centerline, the pivot axis hole with radius R1 from the centerline; and further the lug ears with outside face and inside face; and,
b) wherein the motor body nose is comprised of first and second mated machine flats configured with pivot holes centered on the Z-pivot axis for receiving and fastening the lug ears by the pair of pivot posts, so that the first lug ear inside face contacts the first mated machine face and the second lug ear inside flat contacts the second mated machine flat; and,
c) said pivot assembly further comprising a detent mechanism, wherein the detent mechanism comprises:
i) at least one shallow concavity configured as a detent stop within the surface of the first machine flat of the motor body nose, said concavity at a detent stop radius R2 from the centerline, the detent stop radius R2 being greater then the pivot axis hole radius R1; and,
ii) a detent subassembly hole through the first lug ear at the detent stop radius R2; and,
iii) a detent ball and spring bias means mounted in the detent subassembly hole, so that the ball is compressed against the first machine flat of the motor body nose by the spring bias means; and,
iv) the pair of pivot posts configured with head with head underside face configured to retain the spring in the detent subassembly hole; and,
d) thereby, when the ratchet head is pivoted on the motor body nose so that the detent subassembly hole lines up with the detent stop, the detent ball is springedly arrested in the detent stop.

11. A bendable head ratchet tool comprising:
a) An outside yoke with first and second lug ears, the two lug ears with pivot axis hole centered on a Z-pivot axis with pivot centerline, the pivot axis hole with radius R1 from the centerline, and said lug ears with outside face and inside face; and
b) An inside yoke with first and second mated machine flats for receiving the outside yoke and with pivot holes on the pivot centerline for fastening the lug ears with first and second pivot posts, so that the first lug ear inside face contacts the first mated machine flat and the second lug ear inside face contacts the second mated machine flat; and,
c) further comprising a detent mechanism, wherein the detent mechanism comprises:
i) at least one shallow concavity configured as a detent stop on the surface of the first machine flat of the motor body nose, said concavity at a detent stop radius R2 from the pivot centerline, the detent stop radius R2 being greater then the pivot axis hole radius R1; and,
ii) a detent subassembly hole through the first lug ear at the detent stop radius R2; and,
iii) a detent subassembly comprising a detent ball and spring bias means mounted in the detent subassembly hole, so that the ball is compressed against the first machine flat of the motor body nose by the spring bias means; and,
iv) the first pivot post with head with head underside face configured to cover the detent subassembly hole and retain the spring; and,
d) thereby, when the ratchet head is pivoted on the motor body nose so that the detent subassembly hole lines up with the detent stop, the detent ball is springedly arrested in the detent stop.

12. A bendable head power ratchet tool of claim 11, further comprising a plurality of detent stops and detent subassemblies in a concentric array at the detent stop radius R2 around the pivot centerline.

13. A bendable head power ratchet tool of claim 1 wherein the pivotable shaft coupling does not comprise a spring biasing means, and further wherein the split shaft does not comprise a slip joint.
